(19) United States
(12) Patent Application Publication
(10) Pub. No.: US 2011/0293322 A1
(43) Pub. Date: Dec. 1, 2011

(54) Remanufactured Laser Printer Toner Cartridge having Resilient Module Attachment, and Methods

(75) Inventors: Sagie Shanun, Valley Village, CA (US); Bruce Scott, Granada Hills, CA (US)

(73) Assignee: Wazana Brothers International, d/b/a Micro Solutions Enterprises

(21) Appl. No.: 12/788,492

(22) Filed: May 27, 2010

(51) Int. Cl. G03G 15/00

(52) U.S. Cl. 399/109

(57) ABSTRACT

A remanufactured laser printer toner cartridge has a used magnetic roller section chassis and a used toner hopper assembly, both obtained by splitting toner cartridges along ultrasonic welds. The used magnetic roller section chassis and the used toner hopper assembly are joined with a resilient adhesive along the remnants of the ultrasonic welds. The remanufactured cartridge may include a new pull seal to close the opening between the toner hopper assembly and magnetic roller section chassis.

### TECHNICAL FIELD

This application relates to remanufactured laser printer toner cartridges, and methods of remanufacturing cartridges.

### BACKGROUND

Toner cartridges for laser printers are well known in the art. Generally, a cartridge will include sufficient toner for a large number of “typical” prints, such as 10,000 or 25,000, packaged in a housing which also contains those printing components that require periodic replacement, such as a photosensitive drum, magnetic and charging rollers, a “doctor” blade and a cleaning blade. The printing components and housing typically have a usable life, if properly cleaned and maintained, that greatly exceeds the number of prints for which toner is provided. Hence, toner cartridges are often remanufactured with a new supply of toner.

Remanufactured toner cartridges are both cost effective for consumers and environmentally sound. Original Equipment Manufacturers (OEMs) of printing equipment often provide “recycling” programs that allow consumers to return empty toner cartridges; the returned cartridges are shredded to recover some of the raw materials. Remanufacturing, in contrast, directly reuses most of the components of the cartridges, therefore greatly reducing the amount of material ending up in landfills, and having a substantially better “carbon footprint” than “recycling”. The environmental advantages of remanufacturing become more pronounced when remanufacturing methods allow cartridges to be remanufactured multiple times, rather than just once.

During the remanufacturing process of a toner cartridge it may be necessary to separate portions of the cartridge which were joined by the OEM in a way intended to be permanent. For example, the OEM may ultrasonically weld the cartridge toner hopper and magnetic roller section together. The remanufacturer must develop reliable and efficient disassembly and reassembly methods which preserve dimensional tolerances and other important functional aspects of the cartridge. The remanufactured cartridge should not be the cause of a bad customer experience, such as by leaking toner during shipping or handling. The remanufactured cartridge should also not have the aesthetic appearance of being crudely made, and thus of being perceptibly inferior to the OEM product.

One problem encountered during toner cartridge remanufacture is that rejoined sections may not provide an adequate seal between them. Whatever method is used to separate the cartridge sections, there is the potential for creating rough surfaces that can result in gaps between the sections through which toner can leak. If the cartridge was previously remanufactured, the methods used in the prior remanufacturing process may add to the surface irregularities. One known method of dealing with these gaps and rough areas is to provide a foam seal between the sections. A foam seal, however, is an additional component in a remanufactured cartridge, and adds both cost and labor to the remanufacture process. A foam seal may add thickness that requires deviating from OEM dimensional tolerances. A foam seal may also be ineffective in sealing small imperfections, in that the seal may simply “bridge” over smaller gouges and rough spots.

The design of modern printing systems is cost driven, and tradeoffs are typically made between speed, reliability, print quality, and environmental factors. Some modern office laser printers, such as, for example, the model 4515 produced by the Hewlett-Packard Company, can print as many as 62 pages per minute. At that print speed, the audible noise produced by the printer can be uncomfortably loud in an office environment. Some of the audible noise is attributable to the mechanical vibration of the print cartridge, including the toner hopper. Also, vibration caused by the stirring mechanisms in the toner hopper can be transmitted to other components in the print cartridge, such as the magnetic roller, potentially degrading print quality.

There is thus a need for remanufactured toner cartridges that are reliable and efficient to produce, effectively prevent toner leakage, meet OEM dimensional tolerances, and help reduce noise and print defects resulting from vibration.

### SUMMARY

Embodiments of the invention include the resilient reattachment of a toner hopper section of a remanufactured laser printer toner cartridge. A resilient adhesive, such as a hot melt adhesive, is used to reattach a toner hopper separated from a cartridge during remanufacture; holding and clamping fixtures and a robotic gluing system may be employed to facilitate the method.

In an exemplary embodiment, a remanufactured laser printer toner cartridge has a used magnetic roller section chassis and a used toner hopper assembly, both obtained by splitting toner cartridges along ultrasonic welds. The used magnetic roller section chassis and the used toner hopper assembly are joined with a resilient adhesive along the remnants of the ultrasonic welds. The remanufactured cartridge may include a new pull seal to close the opening between the toner hopper assembly and magnetic roller section chassis.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a schematic diagram illustrating in cross section an exemplary laser printer and toner cartridge;

FIG. 2 and FIG. 3 illustrate how the ultrasonic welds between the magnetic roller section chassis and toner hopper assembly of an exemplary toner cartridge may be split, with FIG. 2 showing the magnetic roller section chassis and toner hopper before splitting, and FIG. 3 showing the magnetic roller section chassis and toner hopper assembly after splitting;

FIG. 4 illustrates how a replacement pull seal is installed on the toner hopper assembly of an exemplary cartridge;

FIG. 5 illustrates equipment which may be used to deposit a resilient adhesive on the magnetic roller section chassis and toner hopper assembly, according to an embodiment of the invention;

FIG. 6 illustrates a holding fixture which may be used in conjunction with the equipment of FIG. 5, according to an embodiment of the invention;

FIGS. 7(a) and 7(b) illustrate resilient adhesive being applied according to an embodiment of the invention, with FIG. 7(a) showing the magnetic roller section chassis, and FIG. 7(b) showing the toner hopper assembly;

FIG. 8 illustrates a clamping fixture for holding a magnetic roller section chassis and a toner hopper assembly in alignment while the resilient material sets or cures, with the clamping fixture in an open position;

FIG. 9 illustrates the clamping fixture for holding a magnetic roller section chassis and a toner hopper assembly in alignment while the resilient material sets or cures, with the clamping fixture in a closed position; and

FIG. 10 is a flow diagram illustrating an exemplary method of the invention.

Reference symbols or names are used in the Figures to indicate certain components, aspects or features shown therein. Reference symbols common to more than one Figure indicate like components, aspects or features shown therein, although the components, aspects or features are not necessarily identical.

### DESCRIPTION OF EMBODIMENTS

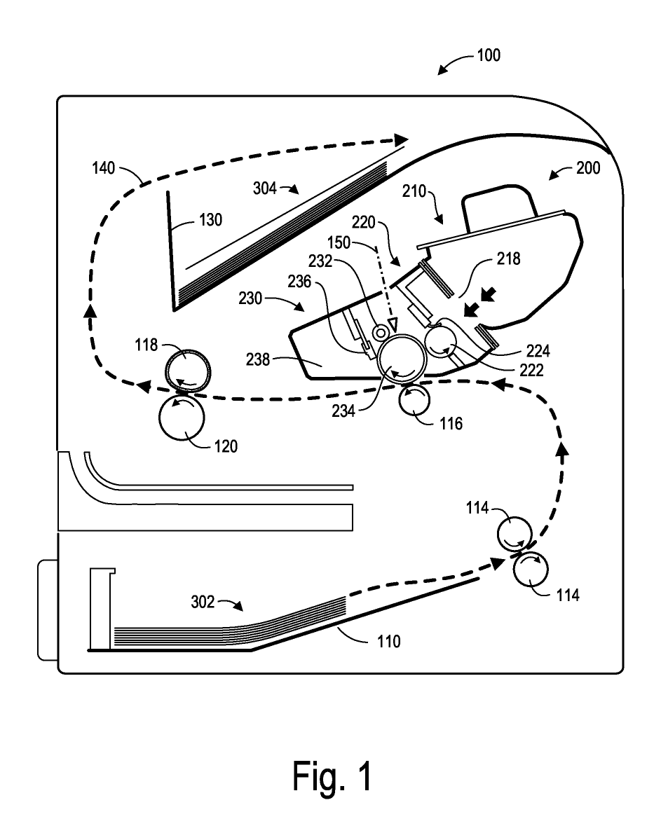

FIG. 1 schematically illustrates in cross section an exemplary laser printer and toner cartridge. The printer 100 includes an input hopper 110 for blank print media 302 such as paper; media handling mechanisms 114 for transporting print media through the printer; print cartridge 200; transfer roller 116; fixing sleeve 118 and pressure roller 120 for fusing toner to the media; and an output media tray 130 for receiving printed media 304. The media path through the printer is denoted by the heavy dashed line 140. FIG. 1 is a simplified representation, and a typical laser printer will include multiple media paths that route print media past the print cartridge. Not shown in FIG. 1are the printing electronics and the writing laser.

Exemplary toner cartridge 200 is made up of multiple modules, which are typically separated during the remanufacture of the cartridge. The modules include a toner hopper assembly 210, a magnetic roller section chassis 220, and a waste hopper assembly 230. Some toner cartridges may include a “developer roller” section chassis instead of a “magnetic roller” section chassis; it is the intent of the applicant that the invention encompass all toner cartridges in which a toner hopper assembly is attached to another cartridge module, regardless of the nomenclature used. Various methods are typically used to join the modules, including mechanical fasteners and ultrasonic welding. In some exemplary toner cartridges the modules are also connected by cartridge end plates (not illustrated in FIG. 1) which add strength and to the cartridge and protect mechanical components, such as gear trains.

The toner hopper module 210 provides storage for a supply of fresh toner for the printer, which passes through an opening 218 in the hopper to the magnetic roller section chassis 220 for utilization by the printer. At the time of manufacture of the cartridge, opening 218 is typically closed with a removable seal (not shown in FIG. 1) to prevent spillage of toner during shipping and storage of the cartridge. The seal is removed at the time the cartridge is installed in the printer. In an exemplary toner cartridge, the toner hopper assembly 210 is rigidly attached to the magnetic roller section chassis, such as by ultrasonic welding, as discussed further below.

During printing, the magnetic roller 222 and “doctor” blade 224 mounted in the magnetic roller section chassis serve to meter toner received from the toner hopper onto the photosensitive drum 234 of the cartridge. Toner adheres to the rotating magnetic roller 222; and the level of toner deposited on the photosensitive drum is controlled by a doctor blade 224.

The waste hopper assembly 230 of the exemplary toner cartridge includes a primary charge roller 232, the photosensitive drum 234, a wiper blade 236, and a waste toner hopper compartment 238. In an exemplary toner cartridge, the waste hopper assembly is retained to the other modules by the cartridge end plates, as discussed above. In operation, the photosensitive drum 234 receives an overall charge from the primary charge roller 232; portions of the drum are then selectively discharged by modulated light from a laser (denoted by the short-and-long dashed line 150), with the pattern of charged and discharged areas corresponding to the image to be printed. The photosensitive drum then rotates past the magnetic roller 222, and toner is selectively transferred to the drum based on the levels of localized charge on the drum. The photosensitive drum then rotates past the media path as print media is moved along the path; an electric charge on transfer roller 116, positioned on the opposite side of the print media, causes the toner on the drum to be attracted to print media.

A residue of toner may remain on the photosensitive drum 234 after the bulk of the toner is transferred to the print media; this residue is removed from the drum by wiper blade 236 and is deposited in the waste toner hopper compartment 238.

A typical toner cartridge includes many additional components not discussed above, such as mechanisms for stirring the toner and for sensing toner levels; the above discussion is intended only to serve as an overview.

After toner is deposited on the print media, the print media is carried along the printer media path to a fuser where the toner is “fused” to the media by heated fixing sleeve 118 and pressure roller 120. The printed media 304 is then deposited in output media tray 130.

An exemplary toner cartridge may be engineered to print a specified number of “typical” pages, such as 10,000 or 25,000 pages, after which the supply of toner is exhausted. The components within the cartridge typically have a usable life significantly beyond the specified number of pages. When a cartridge is depleted of usable toner, it may be remanufactured to restore it substantially to original specifications. Remanufacturing the exemplary toner cartridge generally involves disassembly of the cartridge, cleaning, refurbishing, or replacing the individual components, and reassembly of the cartridge.

Disassembly of the exemplary toner cartridge may begin with the separation of the waste hopper assembly 230 and related components from the magnetic roller section chassis 220 and toner hopper assembly 210. This may involve the removal of cartridge end plates, as discussed above. The components within the waste hopper assembly, including the primary charge roller 232, the photosensitive drum 234, and the wiper blade 236, may then be removed for cleaning, refurbishing, or replacement. The removal of the waste hopper assembly also allows access to the components mounted in the magnetic roller section chassis 220, including the magnetic roller 222 and doctor blade 224, which may similarly be removed.

The toner hopper section 210 is separated from the magnetic roller section chassis 220 during remanufacture primarily to allow the installation of a new toner hopper pull seal. While the cartridge may be refilled and made to function without installing a new pull seal, a new seal is necessary if the cartridge is to enter the normal stream of commerce, where normal handling would cause spillage of toner.

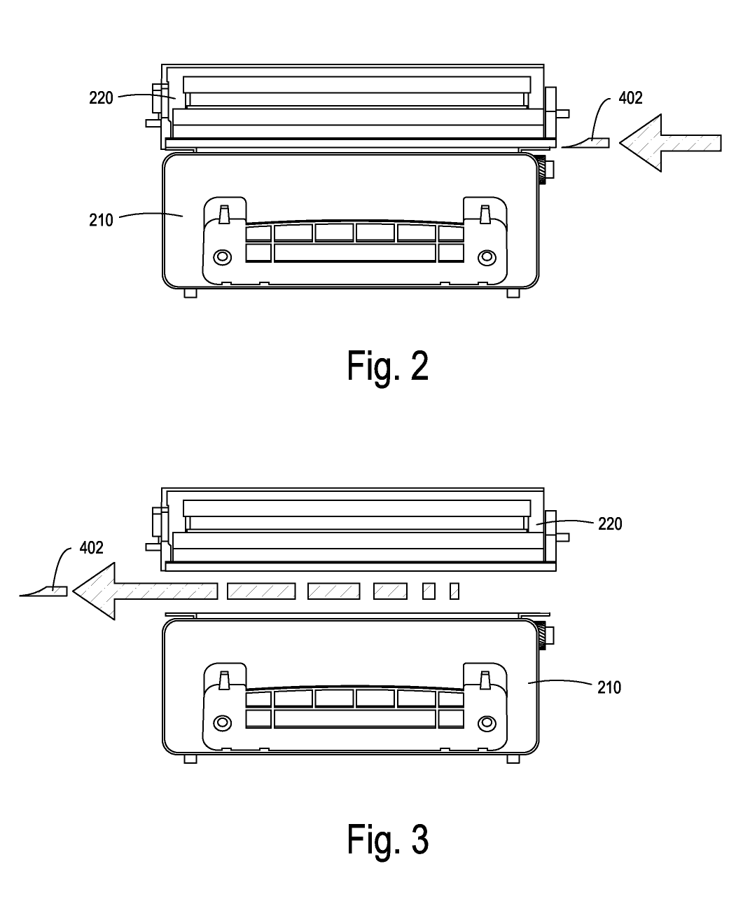

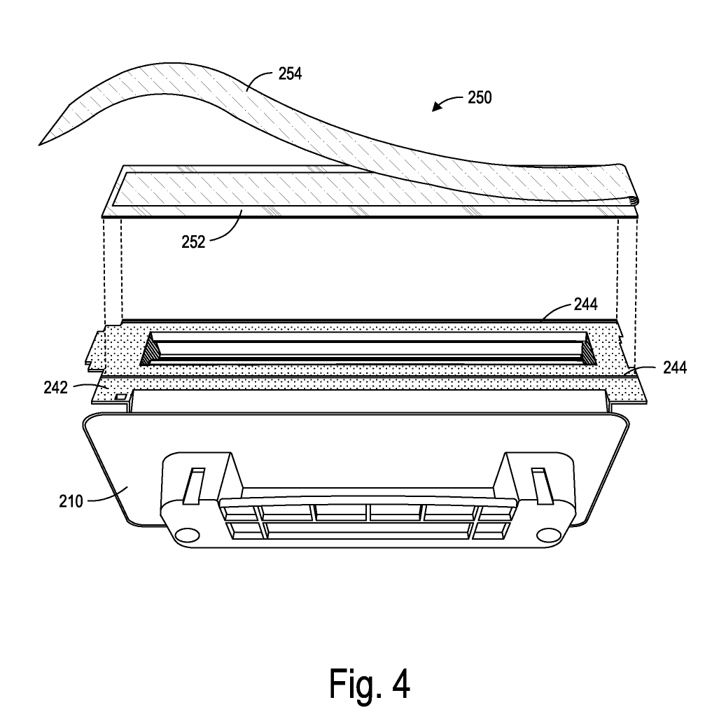

Original equipment manufacturers (OEM) typically achieve the rigidity necessary to maintain the alignment and orientation of components within a cartridge, in substantial part, by ultrasonically welding the magnetic roller section and toner hopper assembly of the toner cartridge together. For the exemplary toner cartridge, the separation of the magnetic roller section chassis and toner hopper assembly may utilize a splitting technique, as described with respect to FIGS. 2 and 3.

Conventionally, separating the magnetic roller section chassis and toner hopper assembly of a cartridge has been accomplished with mechanical saws or grinders to separate the magnetic or developer roller section from the toner hopper section. Conventional toner cartridge separation methods and devices are described in, for example, U.S. Pat. Nos. 5,223,068 (Baley, “Reconditioned and resealed toner cartridge, the method of making the same, and a table saw used in this method”); 5,407,518 (Baley, Jr., “Device for separating a toner cartridge”); 5,525,183 (Baley, “Method and apparatus for reconditioning and resealing a toner cartridge”); and, 5,676,794 (Baley, “Method and apparatus for reconditioning and resealing a toner cartridge”). Typically, conventional techniques use a circular saw blade having a thickness in the range of about 0.020 inch to about 1/16th of an inch to cut or separate the developer roller section from the toner hopper section of the cartridge.

These conventional cutting processes create a problem during re-assembly due to loss of a significant amount of the plastic material that formed the cartridge. This loss of material changes the cartridge and its components dimensionally from the OEM design specifications, and makes difficult the re-assembly of the cartridge with proper orientation and alignment. Separating the cartridge in this conventional way causes a loss of material that must be replaced when re-assembling the cartridge as it is rebuilt. Because of this loss of material, a shim is typically utilized when the cartridge is reassembled. The shims are also referred to as spacers or stepped gaskets, and use of such components carries with it the risk that the repaired toner cartridge will not be returned to the OEM original design specifications.

A splitting technique similar to that contemplated for separation of the toner hopper section 210 and magnetic roller assembly 220 of the exemplary cartridge is disclosed in U.S. Pat. No. 7,590,369 (Wazana et al., “System and Method for Separating and Repairing a Laser Toner Cartridge,” assigned to assignee of the present invention). In general, a cutting blade is forced along the original ultrasonic weld sites of the cartridge, causing the cartridge to split cleanly along the ultrasonic welds without a significant loss of material.

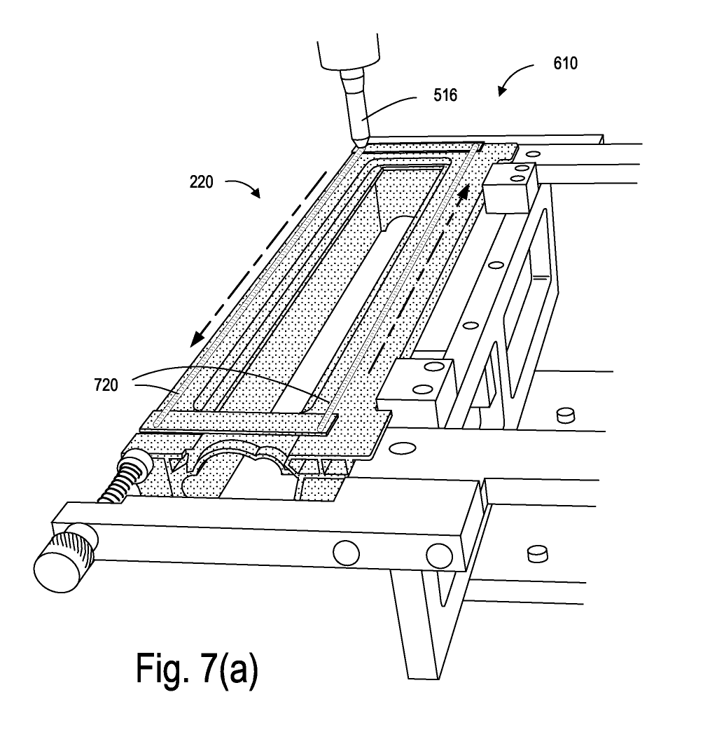

FIG. 2 shows an exemplary magnetic roller section chassis 220 and toner hopper assembly 210 prior to splitting, while FIG. 3 shows the results of the splitting operation (note that in the figures the toner hopper assembly is positioned on the bottom). The ultrasonic welds that join the two modules of the exemplary cartridge are formed of protruding energy directors on the magnetic roller section chassis 220 which mate with corresponding channels on the toner hopper assembly 210 (as best seen in FIG. 6). To “split” the cartridge, cutting blade 402 is forced between the magnetic roller section chassis 220 and the toner hopper assembly 220. The blade is selected such that a clean “split” is achieved; the blade may different cross section than illustrated, as described in U.S. Pat. No. 7,590,369. While U.S. Pat. No. 7,590,369 contemplates the use of an hydraulic system, for the exemplary cartridge sufficient force to separate the toner hopper assembly from the magnetic roller section may be achieved with a manually operated fixture.

While the magnetic roller section chassis 220 and toner hoper assembly 210 from a single cartridge may be utilized in the remanufacturing steps which follow, in practice the two sections may come from different cartridges, since one section from a given cartridge may prove to be defective, or the two sections may simply follow different paths on an assembly line. Although the callout numbers for the two sections are kept consistent throughout the specification and drawings for clarity, embodiments of the invention contemplate the use of magnetic roller assembly chasses and toner hoper assemblies from different or multiple sources.

If the magnetic roller assembly chassis or toner hopper assembly are obtained from a cartridge which is itself a remanufactured cartridge (i.e., if the cartridge has already been remanufactured one or more times), the connections between the two sections may comprise beads of hot melt or other adhesive, according to embodiments of the present invention. An advantage of embodiments of the present invention is that such connections may be more easily separated than are ultrasonic welds, and cleanup of the modules is straight forward, since the adhesive residue may be easily peeled or scraped off the modules.

After splitting, the newly exposed surfaces of the toner hopper assembly and magnetic roller section may be cleaned in preparation for installation of the new toner hopper seal and rejoining of the sections. Cleaning may, for example, involve swabbing the surfaces with a fluid such as alcohol.

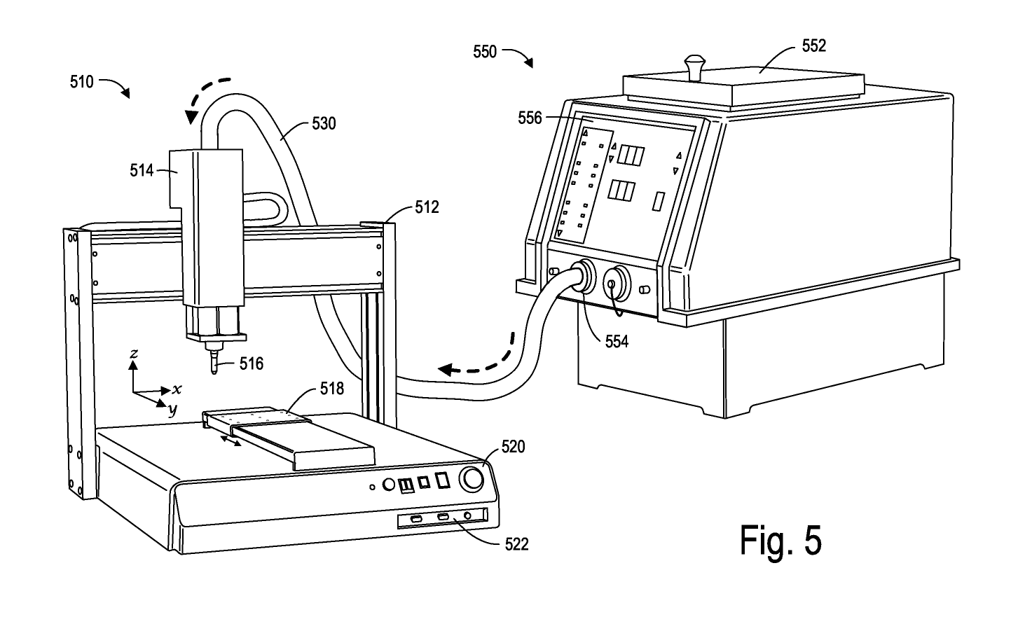

FIG. 4 illustrates how a new pull seal member 250 may be attached to the toner hopper assembly 210 of the exemplary cartridge. The pull seal member may include a rim portion 252 and pull strip 254. The rim portion is attached to the cleaned surface 242 of the toner hopper assembly either with an adhesive which is integral with the lower surface of the rim portion, with a separate adhesive applied to the rim portion or toner hopper surface, or with heat staking or other methods. Tools, such as a pressure roller, may be used to ensure adhesion (not shown). The pull seal member is position between the two remnants of the original ultrasonic welds 244 on the toner hopper assembly.

After the new pull seal is affixed, the toner hopper assembly 220 may be refilled with toner (not shown), or refilling may be done at a later stage of remanufacture. With the new pull seal affixed, the toner hopper may be rejoined to the magnetic roller section, such as with a resilient adhesive. “Resilient” in the context of embodiments of the invention means that the adhesive forms a bond which is somewhat pliant, returning to its original shape after slight deformation. According to exemplary embodiments of the invention, the resilient adhesive may be a hot melt adhesive, although other adhesives, such as silicone adhesives, may be used.

Hot melt adhesives are thermoplastic materials which typically melt above 250 degrees Fahrenheit, and which are applied in a molten state to bond materials upon cooling. Hot melt adhesives typically provide a quick and efficient way to create a bond, are environmentally friendly in that they generally do not contain the volatile organic compounds found in many glues and cements, and are safe to use and efficient to ship and store. They have very good gap filling characteristics, and can be tailored to particular applications by varying the mix of component materials.

For example, the flexibility of the cooled adhesive, the adhesion and tack, and the set speed and open time can be modified by changing the polymer material, the resins, and the waxes in the adhesive, respectively, and their relative proportions in the adhesive. For a given application, selection of a suitable hot melt adhesive will involve testing multiple commercially available formulations, such as those available from companies including HB Fuller, Loctite, and 3M. In one embodiment of the invention, HB Fuller formulation CLRH99879 is used, although other formulations may also be suitable.

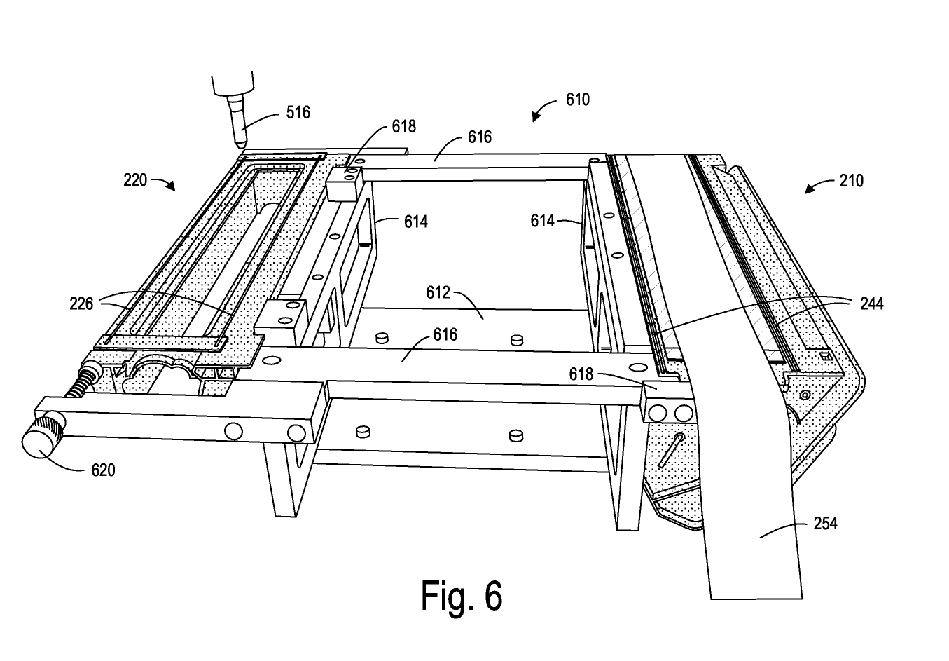

FIG. 5 illustrates exemplary equipment that may be used to automate the deposition of resilient adhesive material, such as a hot melt adhesive, in embodiments of the invention. A programmable benchtop dispensing robot 510, such as produced by I&J Fisnar Company of Wayne, N.J., may be “trained” to dispense a resilient material, such as hot melt adhesive, in a precise three-dimensional (x, y, z) path. A support structure and cross member 512 support a movable head 514 that positions a disposing nozzle 516 in the X and Z axes, while a sliding work table 518 positions the target for the disposing nozzle in the Y axis. A front panel 520 provides user controls, such as controls to select and initiate a programmed dispensing sequence and perform maintenance, such as “purging” the supply lines of fluid material. A connector panel 522 includes connectors to accept signals from an external programming unit (not shown) for initially programming the robot. Other controls and connectors may be located on the rear of the unit (not shown). The dispensing robot may also have safety features such as protective shields to prevent contact with hot surfaces (omitted from FIG. 5 for clarity).

In the exemplary embodiment, the dispensing robot 510 receives a resilient adhesive material, such as hot melt adhesive, through a supply hose 530 from a hot melt tank controller 550, such as produced under the brand name THERMADOSE® by I&J Fisnar Company. The hose 530 connecting the hot melt tank controller and the dispensing robot is typically maintained at an elevated temperature by the tank controller. The hot melt tank controller internally includes a tank for melting the adhesive and a pumping mechanism to impel the adhesive along the hose (not visible in FIG. 5). The internal tank may be accessed through tank lid 552 for replenishing the supply of adhesive, which may be supplied in a variety of physical forms, such as pellet, brick or flake.

The hot melt tank controller further has one or more output ports 554 for connecting the supply hose, and a control panel 556 for setting the desired operating parameters. In one embodiment, the hot melt tank controller 550 may separately control the temperature of the hot melt adhesive at various points along the line of supply; for example, the main tank of hot melt adhesive may be maintained at a temperature of about 250° Fahrenheit (120° C.); the adhesive in the hose may be maintained at a temperature of about 275° Fahrenheit (135° C.); and the dispensing nozzle 516 may be maintained at a temperature of about 300° Fahrenheit (150° C.). Actual temperatures used depend upon a wide range of factors and are best determined empirically.

The automated equipment of FIG. 5 is used together with a holding fixture to deposit resilient adhesive on the magnetic roller section chassis and toner hopper assembly, as shown in FIG. 6. The holding fixture 610 securely holds a magnetic roller section chassis 220 and a toner hopper assembly 210 during deposition of the resilient material (the toner cartridge components are shown with a light stipple to differentiate them from the holding fixture). The exemplary holding fixture is fabricated from heavy aluminum for rigidity and may include a base plate 612, upright sections 614, cross members 616, and various spacers 618 to correctly align the toner cartridge sections. The holding fixture is affixed to the sliding work table 518 of the benchtop dispensing robot 510 shown in FIG. 5, such as with bolts or other fasteners, which provides the necessary movement in the Y axis, as discussed above.

Visible in FIG. 6 are the remnants of the energy directors 226 on the magnetic roller section chassis 220 and the corresponding channels 244 on the toner hopper assembly 210, which together formed the ultrasonic weld joining the modules.

In preparation for the deposition of adhesive, the magnetic roller section chassis 220 and toner hopper assembly 210 are secured in the holding fixture 610, which may involve manipulating one or more engaging mechanisms, such as a spring-loaded clamp 620. Both the dispensing robot 510 and the hot melt tank controller 550 are powered on, and the hot melt adhesive is allowed to warm to the correct temperature. The operator selects the correct program sequence on the front panel 520 of the dispensing robot, and initiates the sequence. In an embodiment of the invention, the dispensing robot moves the dispensing nozzle along a predefined path and deposits a bead of hot melt adhesive substantially along lines corresponding the remnants of the ultrasonic welds on the magnetic roller section and the toner hopper section. In other embodiments, the bead of adhesive may be placed differently, such as alongside, rather than on, the weld remnants.

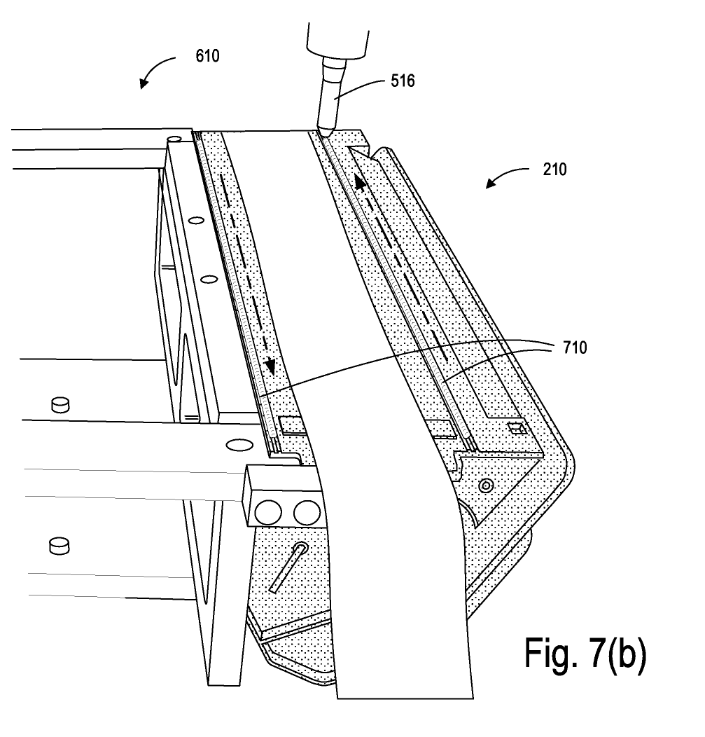

FIGS. 7(a) and 7(b) show the bead of resilient material applied to the two modules of the toner cartridge by the benchtop dispensing robot 510 (the dispensing nozzle of the robot is depicted at 516 in each figure). In FIG. 7(a), a bead of resilient adhesive 720 is applied along each remnant of the ultrasonic weld 226 on the magnetic roller section chassis 220. In FIG. 7(b), a bead of resilient adhesive 710 is applied along each remnant of the ultrasonic weld 244 on the toner hopper assembly 210.

Adhesives typically have an “open time,” the working time during which the surface of the adhesive retains sufficient tack to make a bond, and a “set time,” the time to form a bond of acceptable strength once the surfaces to be joined are brought into contact. In an exemplary embodiment, the hot melt adhesive is selected to have an open time sufficient to allow the magnetic roller section chassis 220 and toner hopper assembly 210 to be properly aligned and brought into their final relative positions. The modules must then be held, or clamped, in the proper relative position for a specified set time, selected to allow efficient work flow in the remanufacture process, while an adequate bond forms.

In an exemplary embodiment, an operator removes the magnetic roller section chassis 220 and toner hopper assembly 210 from the holding fixture 610 once the robotic gluing sequence is completed, and places them in an alignment and clamping fixture.

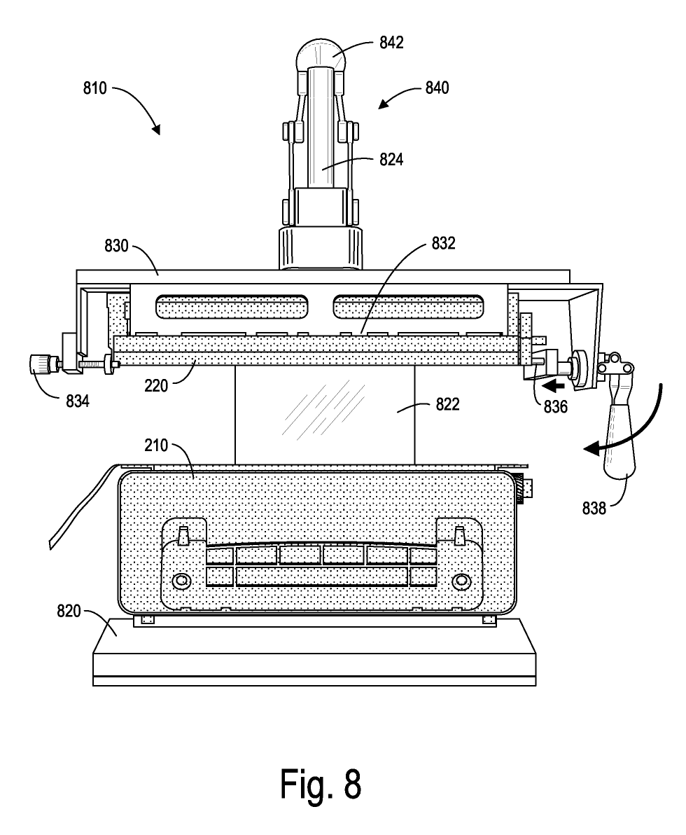

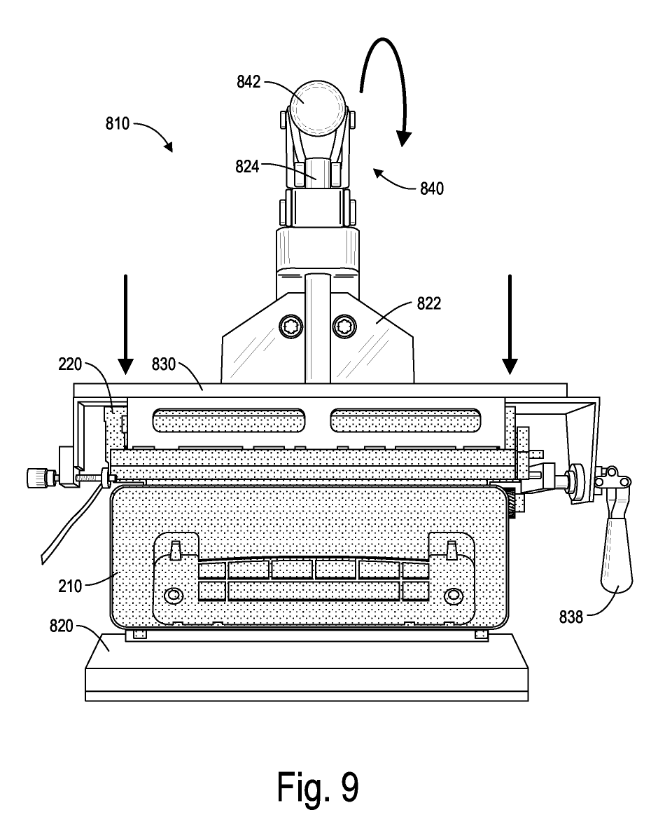

FIGS. 8 and 9 illustrate an alignment and clamping fixture that may be utilized in an embodiment of the invention, with FIG. 8 showing the fixture in an “open” position. Again, the magnetic roller section chassis 220 and toner hopper assembly 210 are shown with a light stipple to distinguish from the alignment and clamping fixture. The alignment and clamping fixture 810 has a lower base section 820 and an upper movable section 830. The base section is configured to hold a toner hopper assembly 210 in a stable position with the newly glued surface facing upward; the upper movable section is configured to hold a magnetic roller section chassis 220 in a stable position, aligned with the toner hopper section, with the newly glued surface facing downward.

The base section 820 includes an upright support 822 terminating in a shaft 824 which is part of an upper toggle clamp 840. The upper toggle clamp has a handle 842 which, when moved from the backward-facing position illustrated in FIG. 8 to a forward position, causes the upper movable section 830 of the alignment and clamping fixture to move downwards towards the base section. Both the base section and upper movable section are constructed of a heavy gauge aluminum for rigidity.

The upper movable section 830 may include mechanisms to precisely align and retain the magnetic roller section, such as notches 832 which engage structural features on the magnetic roller section chassis; fine alignment adjustment mechanisms as depicted at 834; and one or more clamps, such as toggle clamp 838, to secure the magnetic roller section in the movable section (the clamp may have pins 836 which engage structural indentations on the roller section).

In an exemplary embodiment, the magnetic roller section chassis 220 is removed from the holding fixture 610 immediately after the benchtop dispensing robot has completed depositing resilient adhesive along the ultrasonic weld remnants, and is installed in the alignment and clamping fixture, with care taken to avoid contact with the adhesive. Toggle clamp 838 is moved from an “open” position to a “closed” position (as denoted by the heavy arrow) to secure the section in the fixture. The toner hopper section 210 is also moved from the holding fixture to the alignment and clamping fixture once resilient adhesive is deposited on the weld remnants.

FIG. 9 shows the alignment and clamping fixture 810 in a “closed” position. Moving the handle 842 of the upper toggle clamp 840 to a forward position forces the aligned magnetic roller section chassis 220 to move downward and contact the toner hopper assembly 210. After allowing time for the resilient adhesive to set or cure, the toggle clamp 838 on the upper movable section of the fixture is moved to an “open” position, and the joined modules are removed from the fixture.

Since the joined sections are susceptible to mishandling until the cartridge end caps are reinstalled, in one embodiment a temporary clip is installed on the joined sections to protect the newly-glued seam.

Although the described embodiment includes applying a resilient hot melt adhesive to both the magnetic roller section chassis and the toner hopper assembly, which is desirable for proper wetting of the substrates and best adhesion (provided by a “tack to tack” bond), other embodiments of the invention may apply a resilient adhesive to only one of the sections, depending on the characteristics of the selected adhesive and the manufacturing time constraints with respect to “set” or “cure” time.

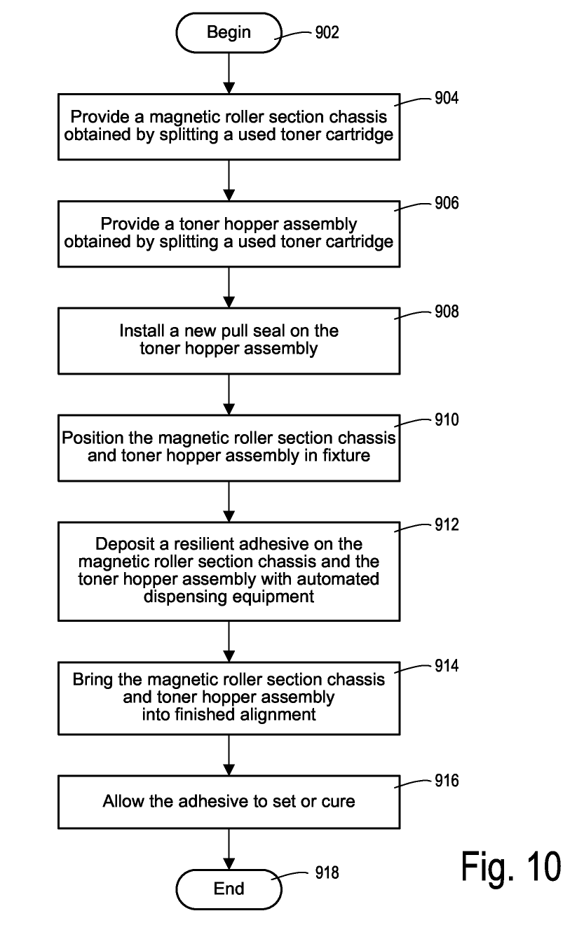

FIG. 10 is a flow diagram illustrating an exemplary method of the invention. The exemplary method begins 902 with providing a magnetic roller section chassis obtained by splitting a used toner cartridge 904. The splitting may be performed as described above; splitting, rather than cutting the cartridge, tends to better preserve the geometry of the cartridge when reassembled. The method then provides a toner hopper assembly obtained by splitting a used toner cartridge 906; the toner hopper assembly may be from the same cartridge as the magnetic roller assembly, or from a different cartridge. In other embodiments, a new, replacement toner hopper assembly may be utilized, since the toner hopper assembly is typically of fairly simple construction and may be inexpensively reproduced. A new pull seal is then installed on the toner hopper assembly 908.

The provided magnetic roller section and toner hopper assembly are then positioned 910 for the automatic deposition of a resilient adhesive. The positioning may be achieved, for example, by a fixture as described above. A resilient adhesive is then deposited with automated dispensing equipment, such as a programmable robotic system as described above. The magnetic roller section chassis and toner hopper assembly are then brought into proper alignment 914, corresponding to their alignment in an original OEM cartridge. The alignment may be provided by an alignment and clamping fixture, as described above. The magnetic roller section chassis and toner hopper assembly are held in alignment while the adhesive is allowed to set or cure 916, and the method ends 918.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

The corresponding structures, materials, acts, and equivalents of all means or step plus function elements in the claims below are intended to include any structure, material, or acts for performing the functions in combination with other claimed elements as specifically claimed.

What is claimed is:

1. A remanufactured laser printer toner cartridge, comprising:
a previously used magnetic roller section chassis having first remnants of ultrasonic welds, the first remnants of ultrasonic welds having been formed when the magnetic roller section was split from an attached toner hopper assembly;
a previously used toner hopper assembly having second remnants of ultrasonic welds, the second remnants of ultrasonic welds having been formed when the toner hopper assembly was split from an attached magnetic roller section chassis;
the previously used magnetic roller section chassis and the previously used toner hopper assembly joined by a resilient adhesive substantially along the first and second remnants of ultrasonic welds.

2. The remanufactured laser printer toner cartridge of claim 1, wherein the resilient adhesive is a hot melt adhesive.

3. The remanufactured laser printer toner cartridge of claim 1, further comprising:
a toner hopper pull seal positioned between the previously used magnetic roller section chassis and the previously used toner hopper assembly.

4. A method of remanufacturing a laser printer toner cartridge, the toner cartridge having a magnetic roller section chassis and a toner hopper assembly, the method comprising:
providing a used magnetic roller section chassis having first remnants of ultrasonic welds, the first remnants of ultrasonic welds having been formed when the magnetic roller section was split from an attached toner hopper assembly;
providing a used toner hopper assembly having second remnants of ultrasonic welds, the second remnants of ultrasonic welds having been formed when the toner hopper assembly was split from an attached magnetic roller section chassis, the used toner hopper assembly further having an opening through which toner may pass;
installing a removable pull seal on the toner hopper assembly to close the opening through which toner may pass;
depositing a resilient adhesive on at least one of the first and second remnants of ultrasonic welds;
aligning the used magnetic roller section chassis and used toner hopper assembly to substantially conform the first remnants of ultrasonic welds and second remnants of ultrasonic welds to the substantially the same alignment as an OEM cartridge; and
allowing the resilient adhesive to set or cure.

5. The method of remanufacturing a laser printer toner cartridge of claim 4, wherein depositing a resilient adhesive comprises depositing a hot melt adhesive.

6. The method of remanufacturing a laser printer toner cartridge of claim 4, wherein depositing a resilient adhesive on at least one of the first and second remnants of ultrasonic welds comprises depositing a resilient adhesive on both the first and second remnants of ultrasonic welds.

7. The method of remanufacturing a laser printer toner cartridge of claim 4, wherein depositing a resilient adhesive is done with a gluing robot.

8. The method of remanufacturing a laser printer toner cartridge of claim 4, wherein aligning the used magnetic roller section chassis and used toner hopper assembly is done with a clamping fixture.

9. A method of remanufacturing a laser printer toner cartridge, comprising:
providing a toner hopper assembly;
providing a new pull seal operable to prevent the passage of toner from a toner hopper assembly to a magnetic roller section chassis;
providing a used magnetic roller section chassis; and
adhering the toner hopper assembly to the used magnetic roller section chassis with a resilient adhesive, the toner hopper assembly and used magnetic roller section chassis aligned substantially as in an OEM toner cartridge, the new pull seal situated between the toner hopper assembly and used magnetic roller section chassis.

10. The method of remanufacturing a laser printer toner cartridge of claim 9, wherein providing a toner hopper assembly comprises providing a previously used toner hopper assembly.

11. The method of remanufacturing a laser printer toner cartridge of claim 9, wherein the used toner hopper assembly and the used magnetic roller section chassis each have the remnants of ultrasonic welds, and wherein adhering the used toner hopper assembly to the used magnetic roller section chassis with a resilient adhesive comprises placing a resilient adhesive along the remnants of ultrasonic welds.

12. The method of remanufacturing a laser printer toner cartridge of claim 11, wherein adhering the used hopper assembly to the used magnetic roller section chassis with a resilient adhesive comprises applying a resilient adhesive to each of the toner hopper assembly and used magnetic roller section chassis, and then bringing the toner hopper assembly and the used magnetic roller section chassis into alignment.

13. The method of remanufacturing a laser printer toner cartridge of claim 12, wherein bringing the used toner hopper assembly to the used magnetic roller section chassis into alignment comprises placing each of the toner hopper assembly to the used magnetic roller section chassis in a clamping fixture, and then closing the clamping fixture.

14. The method of remanufacturing a laser printer toner cartridge of claim 12, wherein the resilient adhesive is a hot melt adhesive.

15. The method of remanufacturing a laser printer toner cartridge of claim 14, wherein the hot melt adhesive is applied to the toner hopper assembly and the used magnetic roller section chassis with a robotic gluing device.

16. The method of remanufacturing a laser printer toner cartridge of claim 9, wherein the new pull seal is adhered to the toner hopper assembly.
